(19) United States
(12) Patent Application Publication
(10) Pub. No.: US 2012/0079916 A1
(43) Pub. Date: Apr. 5, 2012

(54) REINFORCED PARTICULATE ALUMINUM METAL MATRIX COMPOSITE FOR BRAKES

(75) Inventors: AMRO M. AL-QUTUB, DHAHRAN (SA); MIRZA M. BAIG, DHAHRAN (SA)

(73) Assignee: KING FAHD UNIVERSITY OF PETROLEUM AND MINERALS, Dhahran (SA)

(21) Appl. No.: 12/897,651

(22) Filed: Oct. 4, 2010

(51) Int. Cl. C09K 3/14

(52) U.S. Cl. 75/232; 75/228; 75/236; 75/243; 75/244

(57) ABSTRACT

The reinforced particulate aluminum metal matrix composite for brakes is used to form a brake component, such as a brake rotor, a brake coupler or the like. The composite is formed from an aluminum metal matrix reinforced with ceramic particulates. The ceramic particulates have a particulate diameter between about 0.1 and 1.0 micrometers and form greater than about 10% by volume of the reinforced particulate aluminum metal matrix composite.

### BACKGROUND OF THE INVENTION

1. Field of the Invention

The present invention relates to materials used to manufacture brakes, and particularly to a reinforced particulate aluminum metal matrix composite for brakes and brake components, such as brake rotors and brake coupling systems.

2. Description of the Related Art

Brakes for vehicles are well known. Typical brakes rely on friction, thus heat dissipation is of primary concern in brake design. Since the frictionally produced heat must be absorbed and dissipated, the brake rotor typically acts as a heat sink. As the rotor heats up, it absorbs heat, but if the temperature of the rotor increases faster than the rotor can cool down, severe damage to the rotor, the tire, and other wheel components is likely to occur. In most thermal applications, a larger heat sink is used to more effectively drain heat from a system. This typically involves increasing the physical dimensions of the heat sink, but increasing the size of a rotor is usually impractical, as an increase in size also requires an increase in moment of inertia of the rotor.

Thus, it is desirable to design a rotor with a decreased mass but with the ability to better handle the thermal energy transferred thereto from the frictional braking. A large amount of effort has been made by automobile manufacturers to utilize aluminum metal matrix composite (AMC) brake discs in place of conventional gray cast iron brake discs. Such efforts have been undertaken with the goal of utilizing the favorable characteristics of AMCs, such as high thermal conductivity and low density when compared with cast iron. Thermal conductivity and expansion of AMC brake components can be tailored by adjusting the level and distribution of the particulate reinforcement. Thus, silicon carbide reinforced aluminum composites are increasingly being used as substitute materials for cylinder heads, liners, pistons, brake rotors and calipers.

“Metal matrix composites” (MMCs) refer to a kind of material in which rigid ceramic reinforcements are embedded in a ductile metal or alloy matrix. MMCs combine metallic properties (such as ductility and toughness) with ceramic characteristics (such as high strength and modulus), leading to greater strength in shear and compression, as well as higher service temperature capabilities.

The metal matrix is made of a specific metal or metal alloy. The matrix serves as the binder to hold the reinforcement together and to distribute the improved properties, attained via the reinforcement, uniformly or in a specified direction. The total dependency of the composite upon the matrix varies with the combination of matrix and reinforcement type, as well as the combining process used. The use of continuous fibers as reinforcements may result in the transfer of most of the load to the reinforcing filaments, thus the composite strength will be governed primarily by the fiber strength. The primary roles of the matrix alloy are to provide an efficient transfer of the load to the fibers and to blunt cracks in the event of fiber failure. The matrix alloy for a continuously reinforced MMC may be chosen more for toughness than for strength.

On this basis, lower-strength, more ductile, and tougher matrix alloys may be utilized in continuously reinforced MMCs. For discontinuously reinforced MMCs, the matrix may govern composite strength. In this case, the choice of matrix will be influenced by consideration of the required composite strength, and higher-strength matrix alloys may be required.

Reinforcement materials in MMCs are second-phase additions to a metallic matrix that result in some net property improvement, such as an increase in strength. Generally, most reinforcement materials for MMCs are ceramics (oxides, carbides, nitrides, etc.), which are characterized by their high strength and stiffness at both ambient and elevated temperatures. Examples of common MMC reinforcements are SiC, Al₂O₃, TiB₂, B₄C, and graphite. Metallic reinforcements are used less frequently.

The role of the reinforcement varies with its type in structural MMCs. In particulate and whisker-reinforced MMCs, the matrix is the major load-bearing constituent. The role of the reinforcement is to strengthen and stiffen the composite by preventing matrix deformation by mechanical restraint. This restraint is generally a function of the inter-particle spacing-to-diameter ratio. In continuous fiber reinforced MMCs, the reinforcement is the principal load-bearing constituent. The metallic matrix serves to bond the reinforcement, and it transfers and distributes the load. Discontinuous fiber reinforced MMCs display characteristics between those of continuous fiber and particulate reinforced composites. Typically, reinforcement increases the strength, stiffness and temperature capability of MMCs. When combined with a metallic matrix of higher density, the reinforcement also reduces the density of the composite, thus enhancing properties such as specific strength.

Particle or discontinuously reinforced MMCs are of great interest, because they are relatively inexpensive when compared with continuous fiber reinforced composites, and they have relatively isotropic properties compared to fiber-reinforced composites. Aluminum alloys have been used for tribological applications since 1940, when cast aluminum-tin bearings were introduced for heavy machinery. The Al alloys are attractive due to their low density, their capability to be strengthened by precipitation, their good corrosion resistance, their high thermal and electrical conductivity, and their high damping capacity. Aluminum matrix composites (AMCs) have been widely studied since the 1920s, and they are now commonly used in sporting goods, electronic packaging, armor and in the automotive industries. They offer a wide variety of mechanical properties depending on the chemical composition of the Al matrix. They are usually reinforced by Al₂O₃, SiC, C, SiO₂, B, BN, B₄C, and/or AlN. The aluminum matrices are, in general, Al—Si, Al—Cu, 2xxx or 6xxx alloys. As proposed by the American Aluminum Association, the AMCs should be designated by their constituents: accepted designation of the matrix/abbreviation of a reinforcement's designation/arrangement and volume fraction in % with the symbol of type (shape) of the reinforcement. For example, an aluminum alloy AA6061 reinforced by particulates (P) of alumina (Al₂O₃), 22% volume fraction, is designated as “AA6061/Al₂O₃/22P”.

In the 1980s, transportation industries began to develop discontinuously reinforced AMCs. These are attractive for their isotropic mechanical properties (higher than their unreinforced alloys) and their low costs (cheap processing routes and low prices of the discontinuous reinforcement, such as SiC particles or Al₂O₃ short fibers). It is highly desired to improve the fuel consumption rate by a reduction in total weight of vehicles. The brake rotor accounts for a large part of the total chassis weight. Thus, a reinforced particulate aluminum metal matrix composite for brakes solving the aforementioned problems is desired.

### SUMMARY OF THE INVENTION

The reinforced particulate aluminum metal matrix composite for brakes provides an aluminum alloy strengthened with a dispersion of fine particulates, thus increasing the wear resistance thereof.

The composite is used to form a brake component, such as a brake rotor, a brake coupler or the like. The composite is formed from an aluminum metal matrix reinforced with ceramic particulates. The ceramic particulates have a particulate diameter between about 0.1 and 1.0 micrometers and form greater than about 10% by volume of the reinforced particulate aluminum metal matrix composite.

These and other features of the present invention will become readily apparent upon further review of the following specification.

### DETAILED DESCRIPTION OF THE PREFERRED EMBODIMENTS

The reinforced particulate aluminum metal matrix composite for brakes is used to form a brake component, such as a brake rotor, a brake coupler or the like. The composite is formed from an aluminum metal matrix reinforced with ceramic particulates. The ceramic particulates have a particulate diameter between about 0.1 and 1.0 micrometers and form greater than about 10% by volume of the reinforced particulate aluminum metal matrix composite.

The aluminum metal matrix may be formed from any desired aluminum alloy, such as Al—Si, Al—Cu, 2xxx Al alloys, 6xxx Al alloys, 6160 Al alloy, 6061 Al alloy, or combinations thereof. Any desired ceramic material may be used to reinforce the aluminum metal matrix, such as Al₂O₃, SiC, C, SiO₂, B, BN, B₄C, or AlN.

Preferably, the ceramic particulate is substantially spherical in grain contouring, having a particle diameter on the order of about 0.7 micrometers, and may be processed by any suitable powder metallurgy technique or the like. In the preferred embodiment, Al₂O₃ is used to reinforce an aluminum metal matrix formed from 6061 aluminum alloy with an about 20% by volume fraction of the Al₂O₃. In standard nomenclature, the reinforced particulate aluminum metal matrix composite is represented as AA6061/Al₂O₃/20 P.

The aluminum metal matrix composite reinforced with the ceramic particulate may be processed using any suitable conventional technique, such as a melt incorporation and casting technique, powder blending and consolidation, reactive processing, spray co-deposition, stir casting, powder metallurgy or the like.

It is to be understood that the present invention is not limited to the embodiments described above, but encompasses any and all embodiments within the scope of the following claims.

We claim:

1. A reinforced particulate aluminum metal matrix composite for brakes, comprising an aluminum metal matrix reinforced with ceramic particulates, the ceramic particulates having a particulate diameter between about 0.1 and 1.0 micrometers, the ceramic particulates forming greater than about 10% by volume of the reinforced particulate aluminum metal matrix composite.

2. The reinforced particulate aluminum metal matrix composite for brakes as recited in claim 1, wherein the aluminum metal matrix is formed from at least one aluminum alloy selected from the group consisting of: Al—Si, Al—Cu, 2xxx Al alloys, 6xxx Al alloys, 6160 Al alloy, and 6061 Al alloy.

3. The reinforced particulate aluminum metal matrix composite for brakes as recited in claim 2, wherein the ceramic particulates are formed from at least one ceramic material selected from the group consisting of: Al₂O₃, SiC, C, SiO₂, B, BN, B₄C, and AlN.

4. The reinforced particulate aluminum metal matrix composite for brakes as recited in claim 3, wherein the ceramic particulates are substantially spherical particles.

5. The reinforced particulate aluminum metal matrix composite for brakes as recited in claim 1, wherein the ceramic particulates are formed from at least one ceramic material selected from the group consisting of: Al₂O₃, SiC, C, SiO₂, B, BN, B₄C, and AlN.

6. The reinforced particulate aluminum metal matrix composite for brakes as recited in claim 5, wherein the ceramic particulates are substantially spherical particles.

7. A brake component formed of a reinforced particulate aluminum metal matrix, the reinforced particulate aluminum metal matrix being an aluminum metal matrix reinforced with ceramic particulates, the ceramic particulates have a particulate diameter between about 0.1 and 1.0 s micrometers, the ceramic particulates forming greater than about 10% by volume of the reinforced particulate aluminum metal matrix composite.

8. The brake component formed of a reinforced particulate aluminum metal matrix as recited in claim 7, wherein the aluminum metal matrix is formed from at least one aluminum alloy selected from the group consisting of: Al—Si, Al—Cu, 2xxx Al alloys, 6xxx Al alloys, 6160 Al alloy, and 6061 Al alloy.

9. The brake component formed of a reinforced particulate aluminum metal matrix as recited in claim 8, wherein the ceramic particulates are formed from at least one ceramic material selected from the group consisting of: Al₂O₃, SiC, C, SiO₂, B, BN, B₄C, and AlN.

10. The brake component formed of a reinforced particulate aluminum metal matrix as recited in claim 9, wherein the ceramic particulates are substantially spherical particles.

11. The brake component formed of a reinforced particulate aluminum metal matrix as recited in claim 7, wherein the ceramic particulates are formed from at least one ceramic material selected from the group consisting of: Al₂O₃, SiC, C, SiO₂, B, BN, B₄C, and AlN.

12. The brake component formed of a reinforced particulate aluminum metal matrix as recited in claim 11, wherein the ceramic particulates are substantially spherical particles.

13. The brake component formed of a reinforced particulate aluminum metal matrix as recited in claim 7, wherein the brake component comprises a brake rotor.

14. The brake component formed of a reinforced particulate aluminum metal matrix as recited in claim 7, wherein the brake component comprises a brake coupler.
